(19) United States
(12) Patent Application Publication
(10) Pub. No.: US 2025/0005312 A1
(43) Pub. Date: Jan. 2, 2025

(54) 3D PRINTED PHYSICAL INFORMATION STORAGE UNITS AND RESINS FOR 3D PRINTING THE SAME

(71) Applicant: Toyota Motor Engineering & Manufacturing North America, Inc., Plano, TX (US)

(72) Inventors: Yuyang Song, Ann Arbor, MI (US); Masato Tanaka, Ann Arbor, MI (US); Stuart Macrae Montgomery, San Jose, CA (US); Hang Qi, Marietta, GA (US); Liang Yue, Atlanta, GA (US)

(73) Assignees: Toyota Motor Engineering & Manufacturing North America, Inc., Plano, TX (US); Georgia Tech Research Corporation, Atlanta, GA (US)

(21) Appl. No.: 18/215,403

(22) Filed: Jun. 28, 2023

(51) Int. Cl. G06K 19/06; C08L 33/06; C08L 33/08; C08L 33/14

(52) U.S. Cl. CPC G06K 19/0614; C08L 33/066; C08L 33/08; C08L 33/14; B33Y 70/00; B33Y 80/00

(57) ABSTRACT

A 3D printed physical information storage unit includes a grayscale digital light processing (g-DLP) 3D printed monolithic component formed from a resin containing a donor moiety, an acceptor moiety, a rigid moiety, a photoinitiator, and a photoabsorber. The g-DLP 3D printed monolithic component has a first portion with a first Young's modulus and a second portion with a second Young's modulus that is different than the first Young's modulus such that the g-DLP 3D printed monolithic component subjected to a predefined strain exhibits a strain field that provides a machine readable optical image.

### TECHNICAL FIELD

The present disclosure generally relates to physical information storage units, and particularly to physical information storage units formed by 3D printing.

### BACKGROUND

Physical information storage units such as QR codes provide machine readable optical images that contain information specific to a labeled item. In addition, information provided by such physical information storage units can include data such as location data, identification data, tracking data, and anti-counterfeiting data, among others. However, the manufacture of physical information storage units can be complicated and costly.

Digital light processing three dimensional (DLP 3D) printing is a vat polymerization technique that builds 3D components (parts) by curing layer-by-layer a resin using a digital light projector. And grayscale DLP 3D (g-DLP 3D) printing employs grayscale light patterns to obtain functionally graded materials. However, current resins provide limited ranges in stiffness and elasticity.

The present disclosure addresses these issues with the manufacture of physical information units, the resins for g-DLP 3D printing, and other issues related to g-DLP 3D printing.

### SUMMARY

In one form of the present disclosure, a 3D printed physical information storage unit includes a grayscale digital light processing (g-DLP) 3D printed monolithic component formed from a resin that includes a donor moiety, an acceptor moiety, a rigid moiety, a photoinitiator, and a photoabsorber. The g-DLP 3D printed monolithic component has a first portion with a first Young's modulus and a second portion with a second Young's modulus that is different than the first Young's modulus such that the g-DLP 3D printed monolithic component subjected to a predefined strain exhibits a strain field that provides a machine readable optical image.

In another form of the present disclosure, a 3D printed physical information storage unit includes g-DLP 3D printed monolithic component formed from a resin that includes a donor moiety selected from one of 2-hydroxyethyl acrylate, caprolactone acrylate, hydroxypropyl acrylate, 2,3-dihydroxypropyl acrylate, 1,3-dihydroxypropyl acrylate, N-hydroxyethyl acrylamide, and aliphatic urethane-based diacrylate. The resin also includes an acceptor moiety selected from one of aliphatic urethane-based diacrylate and 2-hydroxyethyl acrylate, a rigid moiety is selected from one of isobornyl acrylate, 4-acryloylmorpholine, methyl methacrylate, 2-hydroxyethyl methacrylate, and isobornyl methacrylate, a photoinitiator, and a photoabsorber. The g-DLP 3D printed monolithic component has a first portion with a first Young's modulus and a second portion with a second Young's modulus that is different than the first Young's modulus such that the g-DLP 3D printed monolithic component subjected to a predefined strain exhibits a strain field that provides a machine readable optical image.

In still another form of the present disclosure, a 3D printed physical information storage unit includes a g-DLP 3D printed monolithic component formed from a resin that includes a 2-hydroxyethyl acrylate donor moiety, an aliphatic urethane-based diacrylate acceptor moiety, an isobornyl acrylate rigid moiety, a photoinitiator, and a photoabsorber. The g-DLP 3D printed monolithic component has a first portion with a first Young's modulus and a second portion with a second Young's modulus that is different than the first Young's modulus such that the g-DLP 3D printed monolithic component subjected to a predefined strain exhibits a strain field that provides a machine readable optical image.

These and other features of the g-DLP 3D printed physical information storage units and their manufacture will become apparent from the following detailed description when read in conjunction with the figures and examples, which are exemplary, not limiting.

### BRIEF DESCRIPTION OF THE DRAWINGS

The present teachings will become more fully understood from the detailed description and the accompanying drawings, wherein:

FIG. 1 illustrates a g-DLP 3D printer;

FIG. 2A illustrates a resin according to the teachings of the present disclosure with hydrogen bonding between a donor moiety, an acceptor moiety, and a rigid moiety;

FIG. 2B illustrates the resin in FIG. 2A with cross-linking between the donor moiety, the acceptor moiety, and the rigid moiety;

FIG. 3A is a plot of stress versus strain for tensile test samples manufactured with a g-DLP 3D printer using a resin according to the teachings of the present disclosure and printed at a 0% grayscale level (labeled “G0”), a 10% grayscale level (labeled “G10”), a 20% grayscale level (labeled “G20”), a 30% grayscale level (labeled “G30”), a 40% grayscale level (labeled “G40”), and a 50% grayscale level (labeled “G50”);

FIG. 3B is a plot of stress versus strain for tensile samples manufactured with a g-DLP 3D printer using a resin according to the teachings of the present disclosure and printed at a 60% grayscale level (labeled “G60”) and a 70% grayscale level (labeled “G70”);

FIG. 3C is a plot of stress versus number of cycles for a “G60” tensile sample manufactured with a g-DLP 3D printer using a resin according to the teachings of the present disclosure and subjected to cycles of strain between 200% and 300%;

FIG. 3D is a plot of Young's modulus and glass transition temperature (T_{g}) versus percent grayscale for tensile samples made from traditional materials and tensile samples manufactured with a g-DLP 3D printer using a resin according to the teachings of the present disclosure and printed at G0, G10, G20, G30, G40, G50, G60, G70 grayscale levels;

FIG. 4A illustrates a g-DLP 3D printed component with a physical information storage unit according to the teachings of the present disclosure;

FIG. 4B illustrates a g-DLP 3D printed physical information storage unit according to the teachings of the present disclosure; and

FIG. 4C illustrates a strain field optical image of the g-DLP 3D printed physical information storage unit in FIG. 4B subjected to a predefined stress.

It should be noted that the figures set forth herein are intended to exemplify the general characteristics of the present technology for the purpose of the description of certain aspects. The figures may not precisely reflect the characteristics of any given aspect and are not necessarily intended to define or limit specific forms or variations within the scope of this technology.

### DETAILED DESCRIPTION

The present disclosure provides three dimensional (3D) printed physical information storage units, resins for single-vat single cure g-DLP 3D printing of physical information storage units, and 3D printing of physical information storage units. The resins have a composition that provides highly stretchable soft organogel portions and stiff thermoset portions within a single layer of printing such that a monolithic 3D printed component having one or more stretchable (elastic) soft organogel portions and one or more stiff thermoset portions, without the use or need of multiple vats of different resins, is provided.

The present disclosure also provides printed physical information storage units with one or more stretchable soft organogel portions and one or more stiff thermoset portions. And when the physical information storage units are subjected to or placed under a predefined stress (e.g., greater than or equal to a predefined load or stress value), the stretchable soft organogel portion(s) exhibit a relatively large amount of strain (also referred to herein as a “high strain region”) and the stiff thermoset portion(s) exhibit a relatively small amount of strain (also referred to herein as a “low strain region”). Accordingly, the 3D printed physical information storage units exhibit or have different strain regions storing information that is retrieved via digital image processing.

In some variations, a monolithic structure manufactured with a g-DLP 3D printer using a resin according to the teachings of the present disclosure exhibits Young Moduli ranging from about 10 MPa to about 100 MPa. In at least one variation, a monolithic structure manufactured with a g-DLP 3D printer using a resin according to the teachings of the present disclosure exhibits Young Moduli ranging from about 10 MPa to about 200 MPa. In some variations a monolithic structure manufactured with a g-DLP 3D printer using a resin according to the teachings of the present disclosure exhibits Young Moduli ranging from about 10 MPa to about 300 MPa. And in at least one variation, a monolithic structure manufactured with a g-DLP 3D printer using a resin according to the teachings of the present disclosure exhibits Young Moduli ranging from about 10 MPa to about 400 MPa or from about 10 MPa to about 478 MPa.

In some variations, a monolithic structure manufactured with a g-DLP 3D printer using a resin according to the teachings of the present disclosure exhibits Young Moduli ranging from about 8 MPa to about 100 MPa. In at least one variation, a monolithic structure manufactured with a g-DLP 3D printer using a resin according to the teachings of the present disclosure exhibits Young Moduli ranging from about 5 MPa to about 100 MPa. In some variations a monolithic structure manufactured with a g-DLP 3D printer using a resin according to the teachings of the present disclosure exhibits Young Moduli ranging from about 2 MPa to about 100 MPa. And in at least one variation, a monolithic structure manufactured with a g-DLP 3D printer using a resin according to the teachings of the present disclosure exhibits Young Moduli ranging from about 1 MPa to about 100 MPa or from about 0.5 MPa to about 100 MPa or from about 0.1 MPa to about 100 MPa.

In some variations, a monolithic structure manufactured with a g-DLP 3D printer using a resin according to the teachings of the present disclosure exhibits Young Moduli ranging from about 5 MPa to about 200 MPa. In at least one variation, a monolithic structure manufactured with a g-DLP 3D printer using a resin according to the teachings of the present disclosure exhibits Young Moduli ranging from about 2 MPa to about 200 MPa. In some variations a monolithic structure manufactured with a g-DLP 3D printer using a resin according to the teachings of the present disclosure exhibits Young Moduli ranging from about 1 MPa to about 300 MPa. And in at least one variation, a monolithic structure manufactured with a g-DLP 3D printer using a resin according to the teachings of the present disclosure exhibits Young Moduli ranging from about 0.5 MPa to about 400 MPa or from about 0.1 MPa to about 475 MPa.

In some variations, a monolithic structure manufactured with a g-DLP 3D printer using a resin according to the teachings of the present disclosure exhibits an elastic elongation up to 100%. And in some variations, a monolithic structure manufactured with a g-DLP 3D printer using a resin according to the teachings of the present disclosure exhibits an elastic elongation up to 200%, up to 300%, up to 400%, up to 450%, or over 450%. Stated differently, a monolithic structure manufactured via g-DLP 3D printing using a resin according to the teachings of the present disclosure has at least one portion with low stiffness and high elasticity and at least one portion with high stiffness and high strength as described in greater detail below.

It should be understood that 3D printing allows for the fabrication of components and structures with geometric and material complexities beyond what is physically and/or economically possible with traditional manufacturing techniques such as casting, machining, cold working, hot working, among others. And new 3D printing capabilities have demonstrated use in functional applications or structures such as deployable structures, soft robotics, flexible electrical components, and biomimetic designs. However, many functional applications such as nature-like structures, airless tires, multi-stable absorbers, and 4D printing require the use of materials with vastly different properties. That is, such structures have or require different portions with very different mechanical and/or physical properties.

It should also be understood that DLP 3D printing is a high-speed and high-resolution printing method that has become increasingly popular in recent years. Digital light processing uses a projector to irradiate hundreds or thousands of thin layers of resin having predefined cross-sections of a solid component such that each thin layer is cured and the solid component is manufactured layer-by-layer. In a typical DLP printing process, a single resin vat is used, only z-direction motion of a build plate is needed to form a component, and photopolymerization (or photocuring) of the thin layers occurs in a few seconds. Accordingly, DLP 3D printing is one of the fastest 3D printing technologies. However, the use of a single resin vat makes DLP in general, not suitable for printing components with multiple material properties. Methods using multiple vats have been developed to print two or more materials by transferring a printed component between multiple vats. However, cross-contamination between multiple vats, switching between different resin vats and cleaning significantly slows down the printing speed.

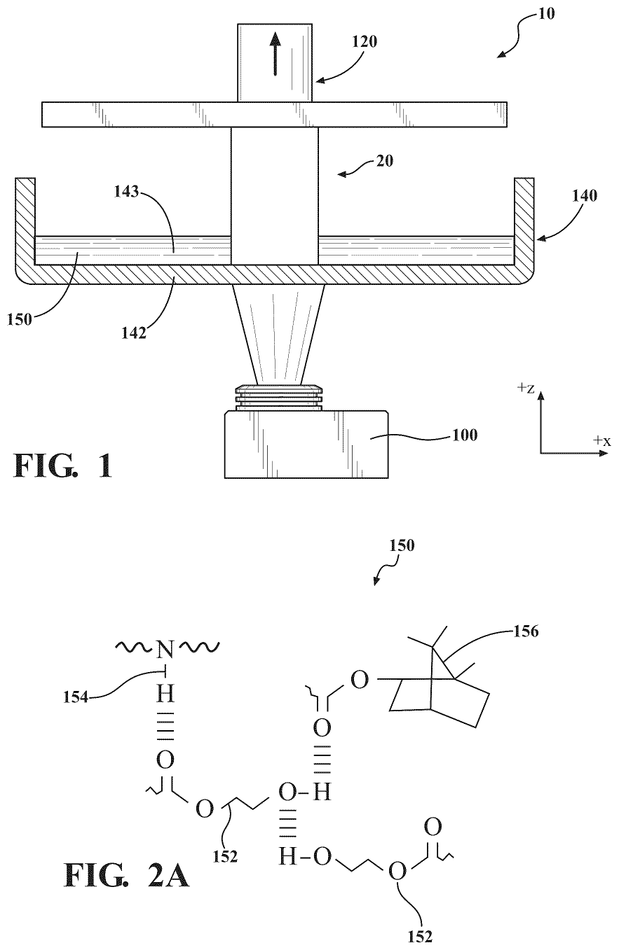

In g-DLP printing, the local degree of monomer conversion (curing) is controlled by light intensity, which is manipulated at pixel level by an input grayscale image. For example, and with reference to FIG. 1, a g-DLP 3D printer 10 with a projector 100, build platform 120, and a single resin vat 140 containing a resin 150 according to the teachings of the present disclosure is shown. The projector 100 is configured to project a grayscale image onto a transparent bottom wall 142 of the single resin vat 140 such that a layer of the resin 150 having a predefined cross-section of a component 20 is illuminated and cured. After the layer of the resin 150 is illuminated (and cured) via the grayscale exposure from the projector 100, the build platform 120 moves in the +z-direction shown in the figure and the resin 150 flows into or between the mostly cured layer of resin and an upper surface 143 of the transparent bottom wall 142. Then, the projector 100 projects another grayscale image onto the transparent bottom wall 142 of the single resin vat 140 such that the most recent layer of the resin 150 is illuminated with another predefined cross-section of the component 20. The process or cycle continues until manufacture of the component 20, layer-by-layer, is complete.

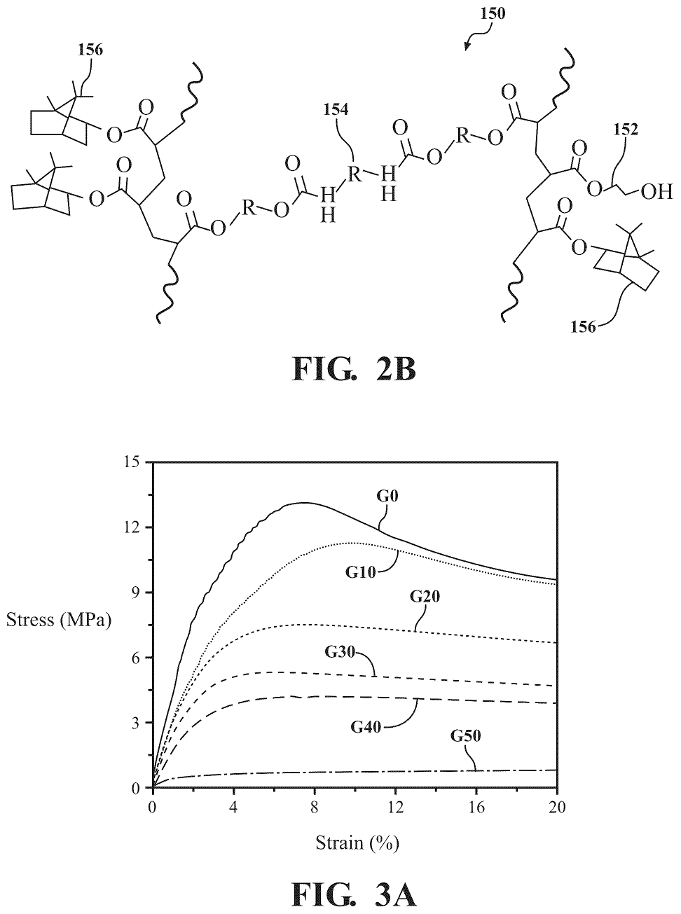

Referring to FIGS. 2A-2B, one non-limiting example of three monomers included in the resin 150 in the resin are shown. Particularly, the resin 150 includes at least one hydrogen bond donating monomer 152 (2-hydroxyethyl acrylate shown in the figures), at least one hydrogen bond accepting monomer 154 (aliphatic urethane-based diacrylate shown in the figures), and at least one rigid monomer 156 (isobornyl acrylate shown in the figures). In some variations, the at least one hydrogen bond donating monomer 152 can also be a hydrogen bond accepting monomer that is different than the at least one hydrogen bond accepting monomer 154 and/or the least one hydrogen bond accepting monomer 154 can also be a hydrogen bond donating monomer that is different than the at least one hydrogen bond donating monomer 152.

In some variations, the at least one hydrogen bond donating monomer 152 (also referred to herein as “donator moiety 152”) is an acrylate monomer with one or more a side groups that include a free carbonyl (—C═O) group or primary, secondary, or tertiary amine side group on an acrylate. And in at least one variation, the at least one hydrogen bond accepting monomer 154 (also referred to herein as “acceptor moiety 154”) is an acrylate monomer with one or more side groups that include a free hydroxy (—OH), a primary or secondary amine (—N(H)—, e.g., a urethane (C(O)—N(H)—), or an imine (—N═). And the at least one rigid monomer 156 (also referred to herein as “rigid moiety 156”) can be an acrylate monomer with one or more side groups that include one or more of cyclohexyls, substituted cyclohexyls, bicyclic side groups (structure) such as isobornyl, norbornyl, and dicylcopentanyl, among others. In addition, the donator moiety 152 and/or the acceptor moiety 154 is an oligomer (e.g., aliphatic urethane-based diacrylate) that functions as crosslinker.

Non limiting examples of the at least one hydrogen bond donating monomer 152 include 2-hydroxyethyl acrylate (2-HEA), caprolactone acrylate, hydroxypropyl acrylate, 2,3-dihydroxypropyl acrylate, 1,3-dihydroxypropyl acrylate, N-hydroxyethyl acrylamide, and aliphatic urethane-based diacrylate. Non-limiting examples of the at least one hydrogen bond acceptor monomer 154 include aliphatic urethane-based diacrylate (AUD) and 2-HEA. And non-limiting examples of the at least one rigid monomer 156 include isobornyl acrylate (IOBA), 4-acryloylmorpholine, methyl methacrylate, 2-hydroxyethyl methacrylate, and isobornyl methacrylate.

In some variations, resins according to the teachings of the present disclosure (also referred to herein simply as “resin 150”) include between about 5 weight percent (wt. %) and about 35 wt. % of the at least one hydrogen bond donator monomer 152, and in at least one variation the resin 150 includes between about 10 wt. % and about 30 wt. % of the least one hydrogen bond donator monomer 152. And in some variations, the resin 150 includes between about 15 wt. % and about 25 wt. % of the least one hydrogen bond donator monomer 152. For example, in at least one variation the resin 150 includes about 20 wt. % of the least one hydrogen bond donator monomer 152.

In some variations the resin 150 includes between about 5 wt. % and about 35 wt. % of the at least one hydrogen bond acceptor monomer 154, and in at least one variation the resin 150 includes between about 10 wt. % and about 30 wt. % of the least one hydrogen bond acceptor monomer 154. And in some variations, the resin 150 includes between about 15 wt. % and about 25 wt. % of the least one hydrogen bond acceptor monomer 154. For example, in at least one variation the resin 150 includes about 20 wt. % of the least one hydrogen bond acceptor monomer 154.

In some variations the resin 150 includes between about 45 wt. % and about 75 wt. % of the at least one rigid monomer 156, and in at least one variation the resin 150 includes between about 50 wt. % and about 70 wt. % of the least one rigid monomer 156 of an overall composition of the resin 150. And in some variations, the resin 150 includes between about 55 wt. % and about 65 wt. % of the least one rigid monomer 156. For example, in at least one variation the resin 150 includes about 60 wt. % of the least one rigid monomer 156.

In some variations, the resin 150 includes a photoinitiator. For example, in some variations the resin includes between about 0.1 wt. % and about 2 wt. % of the photoinitiator, for example between about 0.4 wt. % and 1.6 wt. % of the photoinitiator or between about 0.7 wt. % and about 1.3 wt. % of the photoinitiator. In at least one variation the resin 150 includes about 1.0 wt. % of the photoinitiator. Non-limiting examples of the photoinitiator include photoinitiator 819 (phenylbis(2,4,6-trimethylbenzoyl)phosphine oxide) and camphorquinone.

In some variations, the resin 150 includes a photoabsorber. For example, in some variations the resin includes between about 0.01 wt. % and about 1 wt. % of the photoabsorber, for example between about 0.025 wt. % and 0.5 wt. % of the photoabsorber or between about 0.04 wt. % and about 0.1 wt. % of the photoabsorber. In at least one variation the resin 150 includes about 0.05 wt. % of the photoabsorber. Non-limiting examples of the photoabsorber include methylene, coccine, and tartrazine.

In an effort to better describe the resin 150, its properties, and its capabilities for manufacturing monolithic structures with a range of properties, and yet not to limit the scope of the present disclosure in any manner, one example composition of the resin 150 and numerous examples of monolithic structures and corresponding properties are discussed below.

The resin 150 was prepared by mixing monomers of 2-hydroxyethyl acrylate (Sigma-Aldrich, MO, USA), isobornyl acrylate (Sigma-Aldrich), and AUD (Ebecryl 8413, Allnex, GA, USA) with a weight ratio of 20:60:20. Then, 1 wt. % photoinitiator (Irgacure 819, Sigma-Aldrich) and 0.05 wt. % photo absorber (Sudan I, Sigma Aldrich) were added to the mixture of monomers.

Not being bound by theory, the IOBA and 2-HEA were included as linear chain builders and AUD as a crosslinker. The AUD is a viscous oligomer with high molecular weight aliphatic chains and urethane units, and forms H—N . . . O hydrogen bonds when interacting with 2-HEA and IOBA monomers. Also, the 2-HEA provides abundant —OH groups that form additional O—H . . . O hydrogen bonds.

At a low degree of curing (also known as “degree of cure” and referred to herein as “DoC”), the covalent network with the prevalent hydrogen bonds of the cured resin provides high stretchability in a rubbery state as illustrated in FIG. 2A, while at high DoC, the stiff IOBA exhibits a glass transition temperature (T_{g}) above room temperature as illustrated in FIG. 2B, thereby yielding glassy behaviors with high moduli.

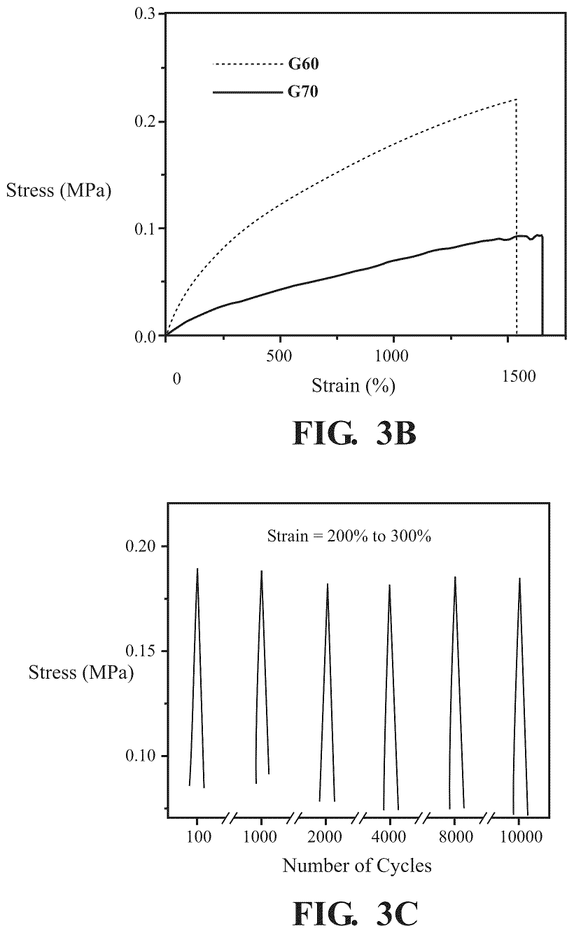

Referring to FIGS. 3A-3D, test results are shown for g-DLP 3D printed components formed from the resin 150 in a bottom-up DLP printer where light was projected from the bottom of the vat. The bottom-up DLP printer employed a 385 nm UV-LED light projector (PRO4500, Wintech Digital Systems Technology Corp., Carlsbad, CA, USA) and a linear translation stage (LTS150 Thorlabs, Newton, NJ, USA). A container with an oxygen-permeable window (Teflon AF-2400, Biogeneral Inc., CA, USA) was used as the resin vat.

Designs of the g-DLP 3D printed components were sliced into image files with a thickness of 0.05 mm and then converted into grayscaled image files with a MATLAB script. The layer-by-layer approach was utilized at the optimized speed of 3 s/layer to print the designed 3D structures. The light intensity of the printer was calibrated with a photometer (ILT1400-A Radiometer, International Light Technologies Inc., MA, USA) before printing.

Uniaxial tension tests of the g-DLP 3D printed components were performed with a universal test machine (Insight 10, MTS Systems Corp., Eden Prairie, MN, USA) with a cross-head speed of 5 mm/min. Dynamic thermomechanical properties were conducted on a DMA machine (Q800, TA Instruments, New Castle, DE, USA) with a temperature ramped at a rate of 10° C./min. The degree of curing was determined using normalized FTIR (Nicolet iS50 spectrometer, Thermo Fisher Scientific, Waltham, MA, USA) peak intensity of the acrylate group present at 809 cm⁻¹. Multiple tests were conducted for each sample to guarantee reproducibility.

It should be understood that the different material properties were defined by the grayscale level of the UV projection, which varied from 0% (full intensity, labeled as G0) to 100% (full dark, labeled as G100). The photopolymerization kinetics were studied with a photopolymerization (PP) model as disclosed by Vitale et al., “Interfacial Profile and Propagation of Frontal Photopolymerization Waves” Macromolecules 2015, 48 (1), 198-205, in order to analyze the correlation of depth-dependent DoC with light dose. Based on a slicing thickness of 50 μm, and using the theoretically predicted correlation from the PP model and experimental trials, a grayscale range from G0 level to G70 (70% darkness) was used to ensure a rapid printing speed and a good shape fidelity. At G0, the light intensity was 24.82 mW/cm² and the DoC was 96% (determined by FTIR measurement) and at G70, the light intensity was 0.85 mW/cm², and the DoC was 55%.

The mechanical properties for structures formed from the resin 150 using the g-DLP 3D printer and printed with the different grayscale levels were evaluated with uniaxial tensile tests, and the thermomechanical properties were determined. As shown in FIG. 3A-3B, the g-DLP 3D printed components gradually became softer from G0 down to G50, with a Young's modulus of 487 MPa at G0. This “stiff state” (G0) showed superior toughness also, which was around 109 J/m³. The fracture toughness was also measured with a tearing test and ranged from 650 to 10000 J/m². The rubbery state G60 and G70 (FIG. 3B) with a conversion around 50˜60% possessed a modulus of 0.38 MPa and 0.1 MPa, respectively, and could be stretched up to about 450%. The extensive presence of hydrogen bonding between the uncured monomers with the crosslinked network made the printed component in a stable organogel state that exhibited excellent elastic properties and resilience even after 10,000 fatigue cycles with high strain between 200% and 300% (FIG. 3C).

The stiff monomer IOBA increased the Tg at high DoC and made the network stiff, which ensured the modulus contrast at different DoC. FIG. 3D summarizes the Young's moduli and T_{g}s at different grayscales, showing a Young's modulus contrast between stiff G0 and soft G70 more than 4800 times.

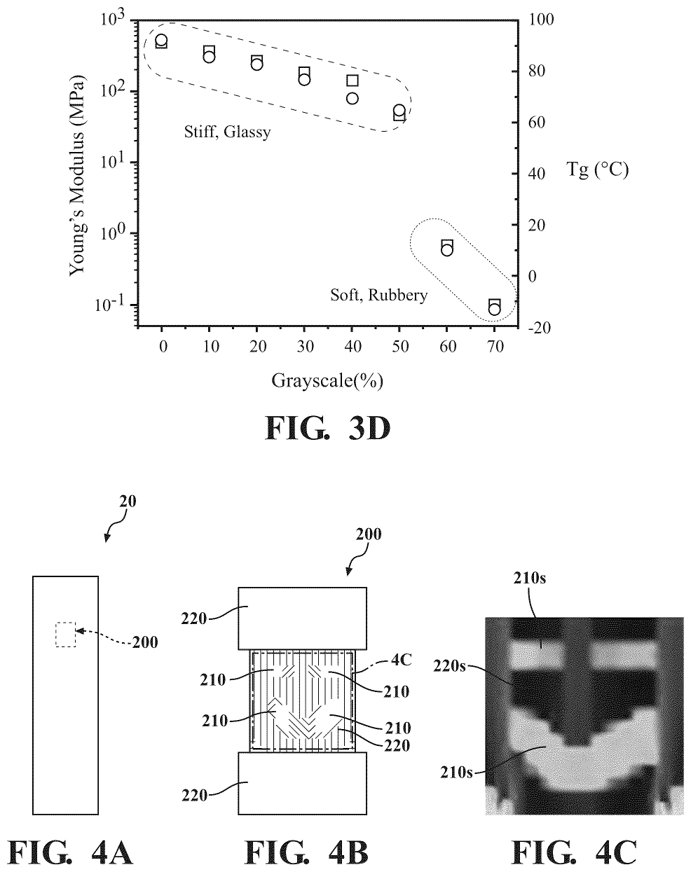

Referring to FIGS. 4A-4C, a g-DLP 3D printed component 20 formed with the resin 150 is shown in FIG. 4A, a g-DLP 3D printed physical information storage unit 200 is shown in FIG. 4B, and a strain field optical image of the physical information storage unit 200 subjected to a predefined stress is shown in FIG. 4C. In some variations, the g-DLP 3D printed physical information storage unit 200 is formed integral with the g-DLP 3D printed component 20. That is, the resin 150 allows for forming (printing) of the g-DLP 3D printed physical information storage unit 200 during forming (printing) of the g-DLP 3D printed component 20. However, it should be understood that in other variations the g-DLP 3D printed physical information storage unit 200 is a standalone unit that may or may not be attached to the g-DLP 3D printed component 20.

The g-DLP 3D printed physical information storage unit 200 includes a plurality of stretchable soft organogel portions 210 and a plurality of stiff thermoset portions 220 such that when the g-DLP 3D printed physical information storage unit 200 is subjected to a predefined load or stress, the stretchable soft organogel portions 210 exhibit more strain that the stiff thermoset portions 220. For example, and with reference to FIG. 4C, the strain field optical image shows high strain regions 210s corresponding to the stretchable soft organogel portions 210 and low strain regions 220s corresponding to the areas or regions between the stretchable soft organogel portions 210.

In this manner, contrast between the high strain regions 210s and the low strain regions 220s are used to form or provide machine readable optical images that store data such as location data, identification data, tracking data, and anti-counterfeiting data, among others. Non-limiting examples of such machine readable optical images include QR code images, data matrix images, bar code images, fine strain field images, course strain filed images, binarized strain field images, among others.

The preceding description is merely illustrative in nature and is in no way intended to limit the disclosure, its application, or uses. As used herein, the phrase at least one of A, B, and C should be construed to mean a logical (A or B or C), using a non-exclusive logical “or.” It should be understood that the various steps within a method may be executed in different order without altering the principles of the present disclosure. Disclosure of ranges includes disclosure of all ranges and subdivided ranges within the entire range.

The headings (such as “Background” and “Summary”) and sub-headings used herein are intended only for general organization of topics within the present disclosure and are not intended to limit the disclosure of the technology or any aspect thereof. The recitation of multiple forms or variations having stated features is not intended to exclude other forms or variations having additional features, or other forms or variations incorporating different combinations of the stated features.

As used herein the terms “about” and “generally” when related to numerical values herein refers to known commercial and/or experimental measurement variations or tolerances for the referenced quantity. In some variations, such known commercial and/or experimental measurement tolerances are +/−10% of the measured value, while in other variations such known commercial and/or experimental measurement tolerances are +/−5% of the measured value, while in still other variations such known commercial and/or experimental measurement tolerances are +/−2.5% of the measured value. And in at least one variation, such known commercial and/or experimental measurement tolerances are +/−1% of the measured value.

As used herein, the terms “comprise” and “include” and their variants are intended to be non-limiting, such that recitation of items in succession or a list is not to the exclusion of other like items that may also be useful in the devices and methods of this technology. Similarly, the terms “can” and “may” and their variants are intended to be non-limiting, such that recitation that a form or variation can or may comprise certain elements or features does not exclude other forms or variations of the present technology that do not contain those elements or features.

The broad teachings of the present disclosure can be implemented in a variety of forms. Therefore, while this disclosure includes particular examples, the true scope of the disclosure should not be so limited since other modifications will become apparent to the skilled practitioner upon a study of the specification and the following claims. Reference herein to one aspect, or various aspects means that a particular feature, structure, or characteristic described in connection with a form or variation is included in at least one form or variation. The appearances of the phrase “in one variation” or “in one form” (or variations thereof) are not necessarily referring to the same form or variation. It should also be understood that the various method steps discussed herein do not have to be carried out in the same order as depicted, and not each method step is required in each form or variation.

The foregoing description of the forms or variations has been provided for purposes of illustration and description. It is not intended to be exhaustive or to limit the disclosure. Individual elements or features of a particular form or variation are generally not limited to that particular form or variation, but, where applicable, are interchangeable and can be used in a selected form or variation, even if not specifically shown or described. The same may also be varied in many ways. Such variations should not be regarded as a departure from the disclosure, and all such modifications are intended to be included within the scope of the disclosure.

While particular forms or variations have been described, alternatives, modifications, variations, improvements, and substantial equivalents that are or may be presently unforeseen may arise to applicants or others skilled in the art. Accordingly, the appended claims as filed and as they may be amended, are intended to embrace all such alternatives, modifications variations, improvements, and substantial equivalents.

What is claimed is:

1. A 3D printed physical information storage unit comprising:
a grayscale digital light processing (g-DLP) 3D printed monolithic component formed from a resin comprising a donor moiety, an acceptor moiety, a rigid moiety, a photoinitiator, and a photoabsorber, the g-DLP 3D printed monolithic component comprising a first portion with a first Young's modulus and a second portion with a second Young's modulus that is different than the first Young's modulus such that the g-DLP 3D printed monolithic component subjected to a predefined strain exhibits a strain field that provides a machine readable optical image.

2. The 3D printed physical information storage unit according to claim 1, wherein:
the donor moiety is in the form of an acrylate monomer with a side group comprising at least one of a free carbonyl, a primary amine on an acrylate, a secondary amine on an acrylate, and a tertiary amine on an acrylate;
the acceptor moiety is different than the donor moiety and is in the form of an acrylate monomer with a side group comprising at least one of a free hydroxy, a primary amine, secondary amine, and an imine; and
the rigid moiety is in the form of an acrylate monomer with a side group comprising of one or more of a cyclohexyl, a substituted cyclohexyl, and a bicyclic structure.

3. The 3D printed physical information storage unit according to claim 1, wherein the donor moiety is selected from at least one of 2-hydroxyethyl acrylate, caprolactone acrylate, hydroxypropyl acrylate, 2,3-dihydroxypropyl acrylate, 1,3-dihydroxypropyl acrylate, N-hydroxyethyl acrylamide, and aliphatic urethane-based diacrylate.

4. The 3D printed physical information storage unit according to claim 3, wherein the donor moiety is between about 10 wt. % to about 30wt. % of an overall composition of the resin.

5. The 3D printed physical information storage unit according to claim 4, wherein the donor moiety is the 2-hydroxyethyl acrylate.

6. The 3D printed physical information storage unit according to claim 1, wherein the acceptor moiety is selected from at least one of aliphatic urethane-based diacrylate and 2-hydroxyethyl acrylate.

7. The 3D printed physical information storage unit according to claim 6, wherein the acceptor moiety is between about 10 wt. % to about 30wt. % of an overall composition of the resin.

8. The 3D printed physical information storage unit according to claim 1, wherein the acceptor moiety is the aliphatic urethane-based diacrylate.

9. The 3D printed physical information storage unit according to claim 1, wherein the rigid moiety is selected from at least one of isobornyl acrylate, 4-acryloylmorpholine, methyl methacrylate, 2-hydroxyethyl methacrylate, and isobornyl methacrylate.

10. The 3D printed physical information storage unit according to claim 9, wherein the rigid moiety is between about 50 wt. % to about 70 wt. % of an overall composition of the resin.

11. The 3D printed physical information storage unit according to claim 10, wherein the rigid moiety is isobornyl acrylate.

12. The 3D printed physical information storage unit according to claim 1, wherein:
the donor moiety is selected from at least one of 2-hydroxyethyl acrylate, caprolactone acrylate, hydroxypropyl acrylate, 2,3-dihydroxypropyl acrylate, 1,3-dihydroxypropyl acrylate, N-hydroxyethyl acrylamide, and aliphatic urethane-based diacrylate;
the acceptor moiety is selected from at least one of aliphatic urethane-based diacrylate and 2-hydroxyethyl acrylate; and
the rigid moiety is selected from at least one of isobornyl acrylate, 4-acryloylmorpholine, methyl methacrylate, 2-hydroxyethyl methacrylate, and isobornyl methacrylate.

13. The 3D printed physical information storage unit according to claim 1, wherein:
the donor moiety is selected from the group consisting of 2-hydroxyethyl acrylate, caprolactone acrylate, hydroxypropyl acrylate, 2,3-dihydroxypropyl acrylate, 1,3-dihydroxypropyl acrylate, N-hydroxyethyl acrylamide, and aliphatic urethane-based diacrylate;
the acceptor moiety is selected from the group consisting of aliphatic urethane-based diacrylate and 2-hydroxyethyl acrylate; and
the rigid moiety is selected from the group consisting of isobornyl acrylate, 4-acryloylmorpholine, methyl methacrylate, 2-hydroxyethyl methacrylate, and isobornyl methacrylate.

14. The 3D printed physical information storage unit according to claim 13, wherein:
the donor moiety is between about 10 wt. % to about 30 wt. % of an overall composition of the resin;
the acceptor moiety is between about 10 wt. % to about 30 wt. % of an overall composition of the resin; and
the rigid moiety is between about 50 wt. % to about 70 wt. % of an overall composition of the resin.

15. The 3D printed physical information storage unit according to claim 14, wherein the donor moiety is the 2-hydroxyethyl acrylate, the acceptor moiety is the aliphatic urethane-based diacrylate, and the rigid moiety is the isobornyl acrylate.

16. A 3D printed physical information storage unit comprising:
a grayscale digital light processing (g-DLP) 3D printed monolithic component formed from a resin comprising:
a donor moiety selected from the group consisting of 2-hydroxyethyl acrylate, caprolactone acrylate, hydroxypropyl acrylate, 2,3-dihydroxypropyl acrylate, 1,3-dihydroxypropyl acrylate, N-hydroxyethyl acrylamide, and aliphatic urethane-based diacrylate;
an acceptor moiety is selected from the group consisting of aliphatic urethane-based diacrylate and 2-hydroxyethyl acrylate;
a rigid moiety is selected from the group consisting of isobornyl acrylate, 4-acryloylmorpholine, methyl methacrylate, 2-hydroxyethyl methacrylate, and isobornyl methacrylate.
a photoinitiator; and
a photoabsorber,
the g-DLP 3D printed monolithic component comprising a first portion with a first Young's modulus and a second portion with a second Young's modulus that is different than the first Young's modulus such that the g-DLP 3D printed monolithic component subjected to a predefined strain exhibits a strain field that provides a machine readable optical image.

17. The 3D printed physical information storage unit according to claim 13,wherein:
the donor moiety is between about 10 wt. % to about 30 wt. % of an overall composition of the resin;
the acceptor moiety is between about 10 wt. % to about 30 wt. % of an overall composition of the resin; and
the rigid moiety is between about 50 wt. % to about 70 wt. % of an overall composition of the resin.

18. The 3D printed physical information storage unit according to claim 17, wherein the donor moiety is the 2-hydroxyethyl acrylate, the acceptor moiety is the aliphatic urethane-based diacrylate, and the rigid moiety is the isobornyl acrylate.

19. A 3D printed physical information storage unit comprising:
a grayscale digital light processing (g-DLP) 3D printed monolithic component formed from a resin comprising:
a donor moiety comprising 2-hydroxyethyl acrylate;
an acceptor moiety comprising aliphatic urethane-based diacrylate;
a rigid moiety comprising isobornyl acrylate;
a photoinitiator; and
a photoabsorber,
the g-DLP 3D printed monolithic component comprising a first portion with a first Young's modulus and a second portion with a second Young's modulus that is different than the first Young's modulus such that the g-DLP 3D printed monolithic component subjected to a predefined strain exhibits a strain field that provides a machine readable optical image.

20. The resin according to claim 19, wherein:
the 2-hydroxyethyl acrylate is between about 15 wt. % to about 25 wt. % of an overall composition of the resin;
the aliphatic urethane-based diacrylate is between about 15 wt. % to about 25 wt. % of the overall composition of the resin; and
the isobornyl acrylate is between about 55 wt. % to about 65 wt. % of an overall composition of the resin.
